(19) United States
(12) Patent Application Publication
(10) Pub. No.: US 2004/0023411 A1
(43) Pub. Date: Feb. 5, 2004

(54) Electrospray air sampler

(76) Inventor: John B. Fenn, Richmond, VA (US)

Correspondence Address: CONN. ANALYTICAL CORP., Att: Joseph J. Bango, Jr., 696 AMITY ROAD, BETHANY, CT, 06524, US

(21) Appl. No.: 10/384,437

(22) Filed: Mar. 10, 2003

Related U.S. Application Data
(60) Provisional application No. 60/362,891, filed on Mar. 11, 2002.

(51) Int. Cl. G01N 1/00

(52) U.S. Cl. 436/174

(57) ABSTRACT

A method of collecting or “gettering” polar trace species from ambient air devoid of the need for forced convention or pumping of the air sample is described. The disclosed invention utilizes a specialized electrospray source, fed by a wick, which attracts and transfers surface charge from spray droplets to ambient polar molecules and particulates which migrate into the path of the electrospray jet source and the target. Collected species may be detected directly on collection surface using suitable detection methodologies or can be stored for subsequent analysis.

### CROSS-REFERNCE TO RELATED APPLICATIONS

Provisional App. No. 60/362,891 was filed on Mar. 11, 2002

### FEDERALLY SPONSORED RESEARCH

Not Applicable

### SEQUENCE LISTING OR PROGRAM

Not Applicable

### BACKGROUND OF THE INVENTION—FIELD OF INVENTION

The invention provides improvements in the sampling of contaminants in air, both particles and polar molecules, including species that may be harmful to people even when they are present at only trace levels in the air those people breathe. The invention comprises a method and apparatus for collecting samples of such contaminants for subsequent analysis and identification. An attractive feature of the invention is that its embodiments can be small, self-contained and very portable units that ceaselessly accumulate samples of air contaminants over long periods of time without any need for attention or maintenance. Thus they can be placed at various strategic locations to provide continuous records of air quality at those locations. Indeed, they are compact enough to be “worn” by individuals so as to provide a running record of contaminants in the air to which those individuals are exposed, wherever they may be or go.

### BACKGROUND OF INVENTION

Contaminant species in the air we breath can cause a broad spectrum of human ailments ranging from relatively mild reactions caused by allergens, e.g. “hay fever”, to serious illness and death from diseases due to pathogens such as anthrax spores and carcinogens such as tobacco smoke as well as particulates from Diesel engine exhausts. Unfortunately, the epidemiologies of such contaminants and the afflictions attributed to them, often lack reliable quantitative data on presence, cause and effect. Part of this lack is because the symptoms characteristic of an ailment may not emerge until long after exposure to its cause. Also, the nature and extent of exposure required to produce those symptoms is rarely well defined. A further complication is that when a patient begins to show such symptoms, it may be difficult if not impossible to know or determine either the contaminants that might have been involved or the nature and extent of the patient's exposure to those contaminants. Another major problem is that monitoring of “air quality” (extent and kind of pollution) is usually carried out only in a few “central” locations. The results are then considered representative of a large surrounding area. But within that area there may be tremendous diversity or heterogeneity in the composition of the air which individuals actually breathe. Some people are outdoors most of the day, others spend various fractions of the day inside buildings that vary widely in the extent to which the air is filtered or otherwise conditioned. The net result of these uncertainties is that truly controlled experiments, in which appearance of symptoms can be reliably related to actual exposure, are quite rare indeed.

This problem was discussed and analyzed at some length in a very provocative talk presented on Jul. 15, 1997, at the George C. Marshall Institute's Washington Roundtable on Science and Public Policy, by Robert F. Phalen. Director of the Air Pollution Health Effects Lab-oratory and Professor of Community and Environmental Medicine, as well as Professor of Occupation and Environmental Health, at the University of California, Irvine. Professor Phalen made this statement: “With respect to atmospheric sciences, one of the biggest research needs involves the development of cheap samplers that could be carried around to measure the doses for individuals. Right now, epidemiologists are justifiably concerned about having to rely on some central air monitor and therefore end up misclassifying everybody's exposure. People are not in one central location. They are indoors, outdoors miles away from the monitor, driving in cars, and so on.”

Rising awareness of the need for such a sampler was one of the fall-outs of the Desert Storm war against Iraq. In the months and years after the fighting was over some of the veterans of that war began to show symptoms of illnesses that many felt were the result of exposure to Chemical Warfare Agents. The Iraqis were known to have had access to such agents but there was no clear evidence that they had been used against US troops. Therefore, the Army refused for a long time to assume any responsibility for the symptoms that developed in some of the veterans. If each individual soldier had been equipped with an appropriate sampler of the air to which he or she had been exposed, it might well have been possible to determine after the fact whether a veteran suffering from an affliction had actually been exposed to an agent known to cause such affliction. More recently, in the aftermath of Sep. 11, 2002, several cases of anthrax occurred which were attributed to spores of the anthrax bacillus in or on envelopes sent through the mail. It emerged that some of those spores became dispersed in the air at post offices or in the homes or offices to which infected pieces of mail had been delivered. If continuous air samplers had been located at strategic locations in such places, or worn by people who worked or lived in them, it might well have been possible to trace the origins of any airborne spores much more quickly and accurately than was then possible, or is now, in the absence of any continuous local sample collection. Since Sep. 11, 2002 the reality of the dangers of terrorism have underlined the need for a variety of counter-measures, one of which is an air sampler which would make it possible to determine the quality of the air to which individuals are and have been actually exposed.

The present invention attempts to help meet that need for a small, lightweight, effective and inexpensive sampler of air contaminants. Such an embodiment of the invention appears capable of providing a cumulative sample, for periods of a month or more, of contaminants in any air to which the sampler has been exposed during that period. To be emphasized is that the invention relates only to obtaining samples for subsequent analysis. It does not provide any identification of the contaminants that it collects. It would be highly desirable, of course, if the identity of a contaminant could be determined on the spot, as soon as it is collected, especially in the case of very toxic contaminants such as agents for chemical and biological warfare. Unfortunately, except for a few special cases, such rapid identification is not yet generally possible with the present state of the analytical art. However, increased research and development during the past decade has led to a growing arsenal of analytical devices and protocols that are increasingly able to identify most of the known agents likely to be used if Chemical and/or Biological Warfare become a reality. Unfortunately, a truly comprehensive analysis now requires a combination of techniques including microscopy, chromatography, mass spectrometry, photometry and “amplification” by culturing. The smallest package that can provide a reasonably comprehensive analysis with these techniques is near the limit of what one rather strong person can carry. Thus, in terms of weight and cost it is not yet feasible for every soldier to carry with him at all times an effective sampler-cum-analyzer capable of on-line-on-the-spot detection and identification of any chemical and biological warfare agents that might be used. However, it is becoming feasible to provide a plurality of less portable analysis stations strategically located so that any soldier in the field would have fairly rapid access to one within a fairly short time or distance from where possible exposure may have occurred. Moreover, an air sampler embodying the subject invention could be sufficiently compact to be attached to one's clothing and be with that soldier wherever he or she goes. Therefore, after any suspected exposure to an agent, or any appropriate interval of time, the sampler could be taken to a nearby field station for rapid analysis to determine whether a collected sample contained any hazardous substances. Moreover, in view of the rapid advances in analytical techniques over the past few years one can reasonably hope that in the fore-seeable future the advent of com-pact portable analyzers with an ability to provide rapid identification of collected samples, on line and on the spot. Even so, almost any analyzer, no matter how small, effective or rapid it might be, must have a sample to analyze. It follows that local sample collection seems likely to remain, for a long time to come, an essential operation in the detection and identification of chemical and biological warfare agents. An exception to this general requirement for an in-hand local sample, of course, would result from the development of practical devices capable of “remote sensing” of such agents, e.g. by probing a distant cloud of particles or gas with a laser beam and interrogating the back-scattered photons. Even so, in times of peace as well as war, there would remain a continuing need for a means of obtaining local samples of air contaminants in civil life that may be present at such low concentrations that long exposures are required to produce any debilitating effects. In such situations periodic analysis of samples from the kind of integrating collector contemplated by the invention could provide early warning of the presence of such contaminants and thus allow corrective measures to be taken to forestall serious damage.

### DESCRIPTION OF PRIOR ART

An detailed examination of the prior art does not reveal any application of electrospray as does the disclosed invention in a “gettering” mode. While numeous applications exist where electrospray ionization is utilized to identify given trace species that may be indicative of a polar molecule or biological agent of interest, such electrospray applications are always require physical introduction of the analyte into the electrospray system. Further, traditional electrospray ionization sources require that the solvent species and analyte be carefully fed via a hydrostatic pressure into the source needle. The disclosed invention obviates the need for hydrostatic feed and permits capture of polar species directly from the ambient air, without the need for additional sample capture and introduction requirements. The disclosed invention is a polar species collection apparatus, not a collection-detection device.

U.S. Pat. Nos. 6,051,189B1, 6,485,686B1, 6,491,872B1, and International Patent No. WO 09/917,096A1 & WO 00/223,178A1 to Wick et al., all describe a means of detecting trace species in air with a collection method necessitating an aqueous stream of 1-10 ml/minute to be pumped into a holding tank and scrubbed by a homogenizer or forced through an orifice. Scrubbed species are subsequently filtered using a high speed centrifuge to increase the target species concentration in the aqueous carrier. In contrast, the disclosed invention captures the target species directly from the air and deposits and concentrates the same onto a surface directly, more efficiently, and without the complication described by Wick et al.

A reference regarding the use of electrospray to identify environmental contaminants is discussed in a paper entitled “Determination of environmental contaminants using an electrospray interface combined with an ion trap mass spectrometer” by Hung-Yu et al., Analytical Chemistry, vol. 65, no. 4, pp. 451-456. This reference describes a conventional electrospray source coupled to an ion trap mass spectrometer. The cited reference requires that ions of interest be mechanically injected into the trap. The disclosed invention captures polar species directly from ambient air and deposits same onto a target without any need for forced convection or other mechanical intervention.

### BRIEF DESCRIPTION OF THE INVENTION

The invention stems from experiments with charged droplets produced by the so-called “electrospray” dispersion of a conducting liquid into gas as a fine spray of tiny charged droplets. Evaporation of solvent from such droplets transforms polar solute species into free gas phase ions. This so-called “Electrospray Ionization” (ESI) is unique in being able to produce intact ions from large and complex organic molecules including peptides, proteins, nucleic acids and carbohydrates. Because such complex and fragile molecules cannot be vaporized without catastrophic decomposition they cannot be ionized by the classical ionization methods. Consequently, they had long been “off limits” as subjects for mass spectrometric analysis. In the mid 1980's ESI was one of two new techniques that led to revolutionary changes in the analytical scene by making possible the production of intact gaseous ions from such large polyatomic molecules. [c.f. U.S. Pat. Nos. of Labowsky et al, 4,531,056, and Fenn et al, 5,130,538] The other technique, “Matrix Assisted Laser Desorption Ionization” (MALDI) is also widely practiced, but its mechanisms and methodology are very different from those in ESI and are not relevant to this discussion.

The subject invention takes advantage of our discovery that the tiny charged droplets produced by electrospraying liquids are extremely effective “getters” for both particles and neutral polar molecules in air and other gases. When a particle or molecule collides with a charged droplet it attaches to that droplet. If the attaching species is a polar molecule, it subsequently becomes a gas phase molecular ion, just as if it had been a solute in the originally electrosprayed liquid. If the attaching species is a particle, it remains attached to the droplet and retains some of its charge to become a charged particle when the last of the drop-let solvent evaporates. Therefore, both particles and polar molecules that encounter such charged droplets become charged them-selves and can thus be driven to a desired target surface by an appropriately directed electric field.

This gettering-charging process is quite effective. In one experiment, for example, a spray was produced by injecting a 50-50 mixture of propanol and water at a rate of 1.75 microliters/min through a short length of hypodermic needle tubing co-linear with the axis of a circular duct 2.2 cm in diameter and 8 cm in length, maintained at 3.3 kV relative to the duct walls. A stream of room air flowed through the duct, counter current to the direction of liquid injection, at a velocity of 12 cm/s corresponding to a volume flow rate of 2.8 L/min. A particle counter based on light scattering indicated a number density of 5000 particles/mL in the entering air with diameters ranging from 0.3 to 3.5 microns, the size range of the counter. The spray current (needle to wall) was only 67 nA. The particle density in the exit air, measured by the same counter, indicated that the charged spray droplets had swept from 93 to 98 per cent of the particles from the air and deposited them on the duct walls, the slightly higher removal efficiencies being obtained with the larger particles.

Equivalent experiments in which the concentration of polar molecules in air, before and after passage through the spray, have not yet been made. However, roughly analogous experiments have been carried in which a liquid was electrosprayed into a bath gas containing polar molecules at very low concentrations. When some of that gas (after complete evaporation of the droplets) was then introduced into the vacuum system containing a mass analyzer, the resulting mass spectrum showed peaks due to those polar molecules. For example, positively charged droplets of 50-50 methanol water sprayed into nitrogen containing caffeine molecules at concentrations of 10 parts per trillion (ppt) produced mass spectral peaks for ions corresponding to protonated caffeine molecules, with signal/noise ratios of 20! Similarly, negatively charged droplets of methanol water containing low concentrations of halide ions were electrosprayed into nitrogen containing vapors of the explosive RDX at concentrations of 30 ppt. The resulting mass spectra showed peaks corresponding to RDX molecules with a halide ion attached. The effective signal/noise ratios were around 10. Similar results have been obtained with cocaine in the positive ion mode and with HMX and TNT in the negative ion mode. It should be noted that these results were based on analog signals from a simple quadrupole mass analyzer having an effective duty cycle of only five per cent or so. Resort to true single ion monitoring and ion counting techniques could doubtless decrease the lowest detectable concentrations by one or two powers of ten. In sum, the ES droplets were indeed effectively gettering polar molecules present at very low concentrations in nitrogen.

What has not yet been determined is the fraction of the total number of those molecules in the gas that were removed by the gettering action of the droplets during passage of the gas through the cloud of droplets from a single spray. It is noteworthy that only a tiny percentage of material in the spray cone actually enters passes the mass spectrometer and less than five per cent of that small fraction was enough to produce a clearly distinguishable peak in the mass spectrum! The invention can be practiced in a way that provides for nearly complete trapping of every chargeable entity, in the air that passes through the spray cone, for periods of time as long as a month or more, requiring no attention or maintenance. It seems quite clear, therefore, that the resulting cumulated samples can contain readily measurable quantities of particles and/or polar molecules that are present in air at extremely low levels indeed.

### DETAILED DESCRIPTION OF THE INVENTION

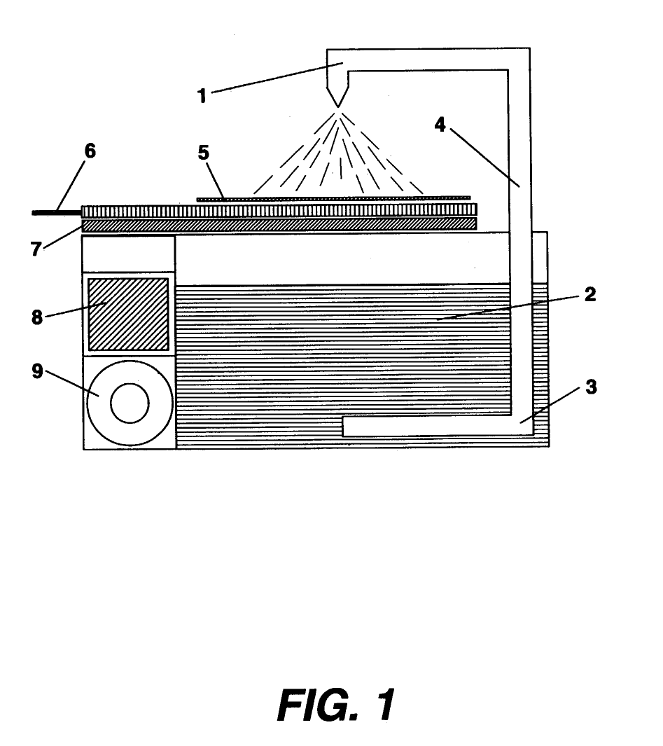

The essential feature of the invention is the use of charged electrospray droplets to collect particles and polar molecules from a gas and deposit them on a target surface where they can be retained for subsequent identification by appropriate analytical procedures. A small, highly portable and inexpensive embodiment of the invention constitutes a collector that can provide virtually continuous sampling of most deleterious contaminants from air in its immediate vicinity for long periods of time at very low cost while requiring little or no attention. Such an embodiment of the invention is shown in FIG. 1.

Container 1 contains spray liquid 2 and also serves as base that supports or houses all the other components of the device. The inlet end of wick 3, a key feature of the invention, extends through conduit 4 from its open inlet end located near the bottom of container 1 to its open exit end located a short distance above the top surface of container 1 facing downward toward that top surface. It is appropriate for the wick to protrude slightly from each end of conduit 4. Capillarity causes liquid 2 to flow through wick 3 from its inlet end in the liquid to its exit end 5 that faces downward toward the surface of target 6 which rests on the top surface of electrode 7 that is electrically isolated from grounded container 1 by insulator 8 and connected to the high voltage terminal (not shown) of converter 9 located in a housing out-side of liquid container 1 and energized by dry cell 10 (e.g. an Alkaline-Manganese Dioxide dry cell size AA.) The overall dimensions contemplated by such an embodiment of the invention can be inferred from the diameter of the AA cell, i.e 0.55 in.)

A key feature of this embodiment is wick 1 that delivers spray liquid from reservoir 2 to the region of high field at the wick tip protruding from the exit end of tube 4 that encloses wick 1 along its entire length to the inlet end that is immersed in liquid 2 contained in reservoir 1. The wick substance comprises a porous matrix of fibers or particles, or interconnecting pores in a monolith of a polymer or some such material. Whatever it may comprise the wick substance must be wettable by spray liquid 2 which will then flow by capillarity through wick 3 to its exit end protruding slightly from the end of tube 4. A collection target 6, e.g. a piece of moist filter paper, opposite the exit end 5 of wick 3, is mounted on the top of plate electrode 6 that is electrically isolated from grounded reservoir 2 by a layer of insulation 7. Converter 8 transforms dc current at 1.5 volts from dry cell 9 to a voltage high enough to maintain electrode 7 at a desired high potential relative to electrode 7, e.g. 3 kV, selected by a control knob (not shown) on converter 9. The resulting potential difference between electrode 6 and wick end 1 produces an intense field at the exit tip 1 of wick 3 which disperses liquid arriving at that tip into a fine spray of charged droplets that are driven by the field to target 5 resting on electrode 6 along with any particles and/or polar molecules that they adsorb from the air or gas through which they pass en route to target 5.

The vitally important property that the wick substance must possess is wettability by spray liquid 2 so that capillarity-driven flow may occur. The characteristic feature of such flow is that it can move liquid to the end of any wick, but no further. However, if some other means of removing liquid from the end of the wick is provided, capillarity driven flow will continuously replace any liquid that leaves. It is this feature of wick flow that has been exploited in oil lamps and candles for at least several millennia. In such devices heat from the flame vaporizes the fuel which is then consumed by the flame to provide the heat that vaporizes the liquid fuel arriving at the end of the wick. In this way capillarity maintains a steady stable flame. The system is inherently self-stabilizing because the capillarity action cannot deliver liquid fuel to the end of the wick any faster than the flame can remove it. By the same token the flame cannot consume the fuel any faster than the wick can supply it.

As described and discussed by Fenn (U.S. Pat. No. 6,297,499 B1) this self-balancing feature of wick flow is particularly advantageous in the electrospray dispersion of liquids into tiny charged droplets. Before the invention described in that patent the technique of Electrospray Ionization Mass Spectrometry (ESIMS) was always carried out by the use of a pump or pressurized gas to pro-vide a flow of sample solution through a small bore tube. Providing a high potential difference between the tube and an opposing counter electrode produces an intense electric field at the tube tip that disperses the emerging liquid into ambient gas as a fine spray of charged droplets. It turns out that stable sprays can be maintained in this way only for certain combinations of flow rate and applied voltage which depend on the properties of the liquid including its surface tension, viscosity and conductivity as well as on the bore and outer diameter of the tube. As a result, successful production of stable sprays for a particular solution could be maintained only for particular combinations of flow rate and applied voltage which could generally be achieved in practice only by trial and error. For this reason, all ESI sources are normally equipped with a flow controlling means based on a positive displacement pump with variable speed, or on providing a variable pressure difference between a reservoir of source liquid and the spray tube exit. The usual practice in the latter option is for the flow to pass through a long capillary of very small bore so that a high pressure difference would be required between the source of the liquid and the spray tip to provide the desired flow rate into the spray. In this way, slight pressure fluctuations at the tube exit would constitute such small changes in the total pressure difference between the liquid source and tube exit that the resulting changes in flow rate would be negligible. One problem with such an arrangement is that even quite small particles can substantially impede flow through the tube. Therefore, one had to be scrupulous in avoiding the presence of even tiny particles in the liquid that might partially plug the tube. Consequently, careful filtration of the sample liquid was often required. No matter whether the flow rate required to provide a stable spray is maintained by a positive displacement pump or pressurized gas on a reservoir, that flow rate has to be selected and controlled. Moreover, because it depends upon the properties of the liquid, especially its conductivity, the flow rate required to produce a stable spray can change from one liquid to another. The use of a wick to supply liquid to a spray avoids all of these problems because of the self-balancing feature of capillarity driven flow. One simply has to provide an intense electric field at the wick tip and the flow will adjust to a stable value for that field. Increasing the applied voltage simply increases field strength and the flow rate, and vice versa. Thus the only variable requiring control is the applied voltage which is very easily regulated. Moreover, the nature of a wick is such that even very small particles are larger than the wick pores, but smaller than the area of porous surface. Therefore, the wick itself acts as a particle filter so that one doesn't have to worry so much about insuring the absence of particles in the liquid.

It is important to consider the nature of the target surface on which the charged droplets are deposited. In the first place it is clear that the charged particles or ions arriving at the target surface 5 in FIG. 1 must be discharged. Otherwise, accumulating charge from the spray will gradually raise the potential of the target, thereby decreasing the field at the wick tip until the spray ceases. Therefore, the target must be an electrical conductor connected to the pole of the power supply opposite in sign from the pole to which the spray source, i.e. the wick in the embodiment of the invention shown in FIG. 1, is connected. Moreover, in order to fulfill the ultimate purpose of the collector, cumulated sample must be periodically removed for analysis and identification of the collected species. A convenient solution to this problem is to use a moistened piece of laboratory filter paper clipped to the top of electrode 6 as the target material. The current to be removed is very small so that even slight moistening should provide sufficient conductivity. However, if a collector is deployed in a very dry environment for weeks at a time, the question arises as to how to keep the target from drying out. To be sure, spray liquid will be continuously deposited on the target, along with collected sample, but at extremely low rates. Moreover, the spray liquid must be sufficiently volatile to evaporate or else all of liquid 2 in the container would ultimately be deposited on the target with rather awkward consequences if it doesn't evaporate. One solution to this problem is to moisten the filter paper initially with a solution in a volatile solvent of some liquid with a very low vapor pressure, e.g. glycerol, ethylene or propylene glycol or poly(ethylene glycol) at a judiciously chosen concentration so that the vapor pressure of the spray liquid would be high enough for evaporation to prevent flooding of the surface with excess liquid. Meanwhile, the non-volatile component of the liquid that is used to moisten the target material could be chosen so as to have a vapor pressure so low that the target would be unlikely to become completely dry, i.e devoid of all the continuously depositing spray liquid.

It seems likely that in some applications one might want to know the time, date and/or hour, that a particular “batch” of sample material had been collected. Such a time record could be readily obtained with only a modest increase in cost and complexity of the system. Target paper in the form of a tape could be fed from a source spool to a receiving spool by a simple spring powered clock-work mechanism. At appropriate intervals the receiving spool would rotate enough to pull a length of new tape into the target position. Alternatively, the tape could be wound up continuously but very slowly. If the rate of tape advance is known, the position of sample material would be an indicator of when it was deposited. In locations where the ambient air has a high concentration of particles or polar molecules, the amount of sample accumulated over a long period of time sample might become quite large so that one might want to resort to the use of such a “moving-tape collector” simply to provide enough storage capacity for the amount of sample accumulated from one analytical interrogation to the next.

There are some other practical considerations. For example, if the collector is to be deployed outdoors in a field or forest it must be sheltered so that rain won't wash away any collected sample. Moreover, to prevent insects from accumulating on the target surface one might have to enclose the collector with a mesh fine enough to screen out insects but open enough to allow free passage of ambient air. Protection from tampering by other wild life such as birds, squirrels or monkeys, might need to be taken. However, most such protective measures, e.g. those used to keep squirrels from removing food from a bird feeder, are quite simple, inexpensive and should be readily adaptable to most situations.

One also wonder whether it might be necessary to supply some forced convection to provide a flow of air through the spray zone to ensure that the air through which the spray flows always has species contents representative of the surrounding air. It seems likely that in any location of interest there would almost always be currents in the surrounding air that would supply “fresh” contaminated air to the spray zone rather continuously. Moreover, the flux of the spray droplets toward the collection surface would entrain ambient air, thereby inducing enough flow to bring “new” air into the spray at a steady rate.

A very attractive feature of the invention is its very low consumption of both spray liquid and electric power. For example, in the cited experiments that collected 93 to 98 per cent of the particles in a stream of air, the spray current was only 67 nano-amperes and the liquid flow rate only 1.75 microliters/min. With a converter that can transform dc current at 1.5 volts to dc current at 3500 volts at an efficiency of only 50 per cent, a single 1.5 volt AA cell can power such a spray for 10 months, consuming only 2.5 milliliters of liquid/day! Thus, a device no larger than a package of cigarettes could collect sample continuously for a month before the liquid would need replenishing. Indeed, the required components are so small that one can contemplate a wide variety devices the size of a magic marker, large fountain pen, vanity case or pocket watch that could collect sample for a week or two at a time without attention while being clipped to a breast pocket or jacket lapel, or worn as a pendant on a necklace. Another alter-native could be to incorporate an embodiment of the invention as part of a book-end, calendar frame or some other trinket that would be “parked” on a desk or work bench where it could sample the air in which an individual spends his or her day.

As noted earlier, the analysis and identification of species in the collected samples are beyond the scope of the invention, which relates only to collecting samples of airborne particles and polar molecules. However, as also pointed out, a growing array of techniques is becoming available for this purpose. A convenient starting point for most of these analyzers would be a sample deposited on a piece of originally clean absorbent fibrous material which would not be a source of misleading signals in whatever analytical procedure is used. e.g. a piece of filter paper. After removal from the sampler the target cum sample could be “digested” in a small amount of solvent to leach out the soluble species. Ultra-centrifugation would separate the soluble and insoluble species. The resulting clear solution could then be interrogated by some combination of suitable techniques that can be judiciously selected by those skilled in the art. Such techniques might involve chromatography, electrophoresis, mass spectrometry, spectrophotometry, ion mobility, and the like, before or after culture in a nutrient medium. The insoluble portion of the centrifuge could also be separately analyzed by some combination of the techniques that have been developed for non-volatile materials, e.g. desorption by a spark or laser photons, followed, for example by analysis of the resulting vapor by techniques such as emission or absorption spectrometry, mass spectrometry, nuclear magnetic resonance, or electron spin resonance.

The experimental results described earlier clearly demonstrated that the tiny charged droplets produced by electrospray dispersion of a liquid are extremely effective getters for both small particles and polar molecules. This specificity for polar molecules that is highly advantageous because it means that the droplets ignore essentially all the major components of “pure” air, e.g. nitrogen, oxygen, and argon which are non-polar. Nor do carbon dioxide or water vapor pose a problem. Unfortunately, the droplets also ignore non-polar molecules that might be contaminants of interest, e.g. hydrocarbons and halogenated hydrocarbons. However, many if not most toxic species are polar and therefore attach to the droplets and retain some of their charge after the droplet's solvent has evaporated. Moreover, even very small particles of non-polar species are often large enough to be polarized by a droplet's charge so that the droplet and/or its charge become bound together to form a charged particle that is then attracted to an electrode by the field due to a potential difference between the sprayer and the electrode. In a very real sense the gettering of particulate matter by charged droplets is very similar to the more familiar electrostatic precipitation which is very effective and widely used in gas-cleaning applications ranging from removal of fly ash in stack gas from coal-fired power plants to the removal of dust particles from household air. The difference is that in electrostatic precipitators the charging of the particles is by corona discharges which consume substantial amounts of power. They do produce large numbers of both positive and negative ions (including electrons) but those ions are not appreciably or effectively separated so most of them simply recombine and are not available for charging the particles and the polar molecules of interest. Moreover, many such polar molecules of interest are polyatomic and thus can be decomposed by the rather violent conditions in a discharge. Furthermore, discharges in air inevitably produce ozone, which is toxic. Although the amount of ozone produced is generally not large enough to produce appreciable damage to people during a relatively short exposure time, it is sufficient to kill many if not most of the microbes and viruses that may be present in a sample collected by electrostatic precipitation. Such destruction of those organisms would inhibit any attempts to “amplify” any identfying “signal” that could be achieved from such organisms if they were allowed to grow and multiply in a culture of a collected sample.

In contrast, the electrospray production of charged droplets is due to the removal of positive or negative charges from the liquid at the interface between the liquid and an electrode. The charge that is deposited on that electrode flows by conduction through a wire back to one pole of the power supply, leaving a net excess of cations or anions in the liquid that forms the charged droplets. The charged droplets then travel through the gas to a counter electrode where they deposit their excess charge that then flows back to the power supply through some conducting path, e.g. a wire, thereby completing the circuit. The total numbers of free charges produced in electrospray are much smaller than in a corona, but all of those charges are available for deposition on particles or polar molecules in the gas. In the case of coronas there is little separation of charges of opposite sign so most of them recombine during gas phase encounters, thereby producing thermal energy that simply raises the gas temperature. Moreover, no ozone is produced during electrospray dispersion so that any living organisms in the collected sample can survive and multiply in a subsequent culture of that sample. In fact experiments have shown that viruses in a solution that is electrosprayed into a vacuum system containing a mass analyzer, then removed from the vacuum system after passing through the mass analyzer, have retained their viability and can multiply in a culture!

The vitalizing feature of the invention is provision of a relatively small self-contained device in which electrospray droplets are used to deposit charge on particles and polar molecules in a gas and then remove those charged species from the gas by an appropriately disposed electric field. It is clear that many variations and embodiments of this concept will occur to those skilled in the art but they are covered by the invention as it is defined in the following claims.

1. A method for collecting samples of contaminant species in a gas which includes the following steps:
(a) Providing a wick through which a desired electrically conducting liquid will flow by capillarity forces, said wick being encased in a tube or coating that prevents evaporation of liquid from the outside lateral surface of said wick, said tube or coating being slightly shorter than said wick so that a short length of said wick can extend by a desired amount from at least one end of said tube or coating;
(b) Immersing one end of said encased wick into a body of said desired conducting liquid contained in said suitable reservoir,
(c) Placing the other end of said encased wick opposite a desired target surface and applying an electric potential difference between said liquid in said reservoir and said target surface large enough to disperse liquid emerging from the wick into a fine electrospray of charged droplets and to drive said droplets and any other charged species to the surface of said target surface,
(d) Providing free access to the spray region of the gas or vapor in which said polar molecules or polarizable particles are dispersed and from which they are to be collected, so that at least some of said polarizable particles and molecules contained in said gas or vapor will be entrained by said spray of said charged droplets and deposited on said target surface.
(e) Accumulating said polarizable particles and molecules on said target surface for a desired period of time and then deter-mining their identities and relative abundance's by suitable analytical means.

2. A method as in claim 1 in which the target surface comprises
a replaceable piece of absorbent material such as paper or cloth attached to a conducting surface which serves as a counter-electrode to said wick, said piece of absorbent material becoming electrically conductive after being wetted by said electrospray droplets.

3. A method as in claim 1 in which the source of potential difference between the target surface and the wick contains as essential elements a dry cell or battery, an alternator, and a step-up transformer.

4. A method as in claim 2 in which the absorbent material is a section of a long piece of tape wound on a source spool, said piece of tape being rewound on a receiving spool after passing over said electrode surface in contact therewith, said receiving spool being slowly rotated at a known speed so that the composition of material deposited by said spray on said target at any point along the length of the tape can be related to the time at which that section of said tape was collecting deposited material from said spray.

5. An apparatus for collecting on a target surface polar molecules and polarizable particles dispersed in a gas, said apparatus including as essential elements a target collection surface, a means of providing a substantial difference in electric potential between said collection surface and an opposing source of electrically conducting liquid, said opposing source comprising one end of a wick element through which an electrically conducting liquid can flow by capillarity from the other end of said wick element, said other end of said wick element being immersed below the surface of a body of said conducting liquid contained in a suitable reservoir.

6. An apparatus as in claim 5 in which the opposing source of electrically conducting liquid comprises a plurality of said wick elements.
